(19) United States
(12) Patent Application Publication
(10) Pub. No.: US 2004/0027383 A1
(43) Pub. Date: Feb. 12, 2004

(54) Method for agglomerating onscreen objects

(76) Inventor: Denny Jaeger, Oakland, CA (US)

Correspondence Address: Harris Zimmerman, Law Offices of Harris Zimmerman, Suite 710, 1330 Broadway, Oakland, CA, 94612, US

(21) Appl. No.: 10/635,745

(22) Filed: Aug. 5, 2003

Related U.S. Application Data
(63) Continuation-in-part of application No. 09/880,397, filed on Jun. 12, 2001.
Application No. 09/880,397 is a continuation-in-part of application No. 09/785,049, filed on Feb. 15, 2001.

(51) Int. Cl. G09G 5/00

(52) U.S. Cl. 345/769

(57) ABSTRACT

A method for user customization of a graphic user interface includes the steps of displaying two onscreen objects, and dragging or otherwise moving one of the objects to be superimposed or intersecting the other object. The objects are combined so that the appearance of at least one object is maintained, and the other object is accessible by click/tap. For example, an onscreen switch may be combined with a photo image, the photo persisting while the switch is invisible, and the switch function is actuated by clicking on the photo image.

### CROSS-REFERENCE TO RELATED APPLICATIONS

This application is a continuation-in-part of U.S. patent application Ser. No. 09/880,397, filed Jun. 12, 2001, which is a continuation-in-part of U.S. patent application Ser. No. 09/785,049, filed Feb. 15, 2001, for which priority is claimed. The entireties of the prior applications are incorporated herein by reference.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to methods and devices for entering user inputs into an electronic device, and, more particularly, to machines such as computers that include a screen display and graphic input means for the user.

2. Description of Related Art

The copending patent applications captioned above describe a graphical user interface for a machine having a screen display. A significant feature of the interface is that it provides the means for hand drawn entry of on-screen objects which may be associated with functions, files, connections, and other objects or actions accessible by the system to carry out the user's desired purpose, whatever it may be. A fundamental aspect of this interface is the ability to carry out commands and actions corresponding to the hand drawn inputs as they are applied to any on-screen object, including (but not limited to) objects representing files (text, data, sound, video, graphics, photos, and the like), functional devices (audio processing, video processing, graphic and photo processing, text editing, data processing, internet communications, and the like), and interconnecting arrows and lines that link these files and functional devices in on-screen arrangements that are drawn by the user to accomplish desired tasks. The prior related applications also introduce arrow logics as a method for inputting transactions involving objects displayed onscreen through the use of arrows and lines drawn between such objects.

### BRIEF SUMMARY OF THE INVENTION

The present invention generally comprises a method for user customization of a graphic user interface for an electronic device that includes a screen display. More specifically, in a computer-user interface that provides recognition of hand-drawn inputs, and assignment of the inputs to functions, files, connections, and other objects or actions accessible by the system to carry out the user's desired purpose, the invention provides a computer system in which one onscreen object may be combined with a second onscreen object, and one of the onscreen objects may become invisible in the transaction. Thus, for example, an onscreen object such as a touch-actuated switch may be dragged (or directed by appropriate arrow logic inputs) to overlay another onscreen object, such as a graphic object like a photo. The switch may become invisible, while retaining its functionality, and the photo image will be displayed in conjunction with the switch position, whereby the switch function is effectively combined with the photo image.

Likewise, the method may include directing or dragging an object, such as graphic object, to be superimposed on a functional object such as a switch or the like, the graphic object substantially or completely obscuring the view of the underlying functional object. The overlaying object is made touch-transparent, so that any click or touch onto the graphic object is transmitted to the functional object underneath, whereby the functionality of the underlying object is effectively combined with the overlying object.

The method is not limited to the use of graphic objects or functional objects, but may be used to combine any two onscreen objects where the combination creates a beneficial joining of characteristics of one object with another. Without the invention, software writers would have to create code to recognize every user customizable item that is desired to be used in the assignment process, resulting in an unacceptably large amount of code. This invention enables software writers to use a much smaller software package to recognize a small group of objects, and provide virtually infinite customization by the user through user-directed combination of the machine recognizable objects with a large number of onscreen objects. Thus, for example an onscreen button that commands an instant message to be sent to a particular individual may be melded with a photo image of that individual. The button may be made invisible and the button function is accessed by recourse to the photo image, so that the user may click or tap on the photo to direct an instant message to that person.

The method of the invention may include a further step of “gluing” together the two superimposed objects, whereby the glued objects are joined as if mechanically bonded; e.g., for movement by the user on the screen, for arrow logic commands, and the like. This gluing step is made explicit through the use of an info canvas that elicits a response from the user; i.e., yes or no to gluing the two objects. This gluing step eliminates accidentally combining two onscreen objects by unintentionally overlapping or intersecting them.

In general, the invention deals with two broad classes of onscreen objects: 1) those that have received an assignment, such as a function (i.e. switch, fader) or action (i.e., open a file, display a text portion), and, 2) those that have not received an assignment. The combination of an object that has an assignment with an object that has no assignment, or another object that has an assignment, may be carried out through explicit steps (described below), or may be accomplished merely by the context in which the two objects are combined. The following contexts are illustrative, but not limiting examples:

1. Dragging a first object over a second object having an assignment partially or completely obscures the second object, and automatically causes the first object to be touch transparent so that a click or tap applied to the first object is transmitted to the second, underlying object.

2. Simply gluing an assigned-to object to any graphic object, picture object, or video object results in the top object becoming touch transparent with respect to the bottom object.

3. Dragging an assigned-to object over a graphic object causes the assigned-to object to become invisible, but still functional, so that the graphic object is visualized and the functional object may be actuated by touch or click.

4. Dragging a graphic or photo object over a switch object, so that the perimeter of the switch remains visible, causes the overlying object to remain visible but become touch transparent. When the switch or overlying object is touched or clicked, the switch changes state and alters its color or brightness to indicate actuation.

5. Dragging one assigned-to object over another assigned-to object creates a combined onscreen toggle object, whereby clicking once on the combined object actuates the first object and clicking again actuates the second object.

In this patent application the terms gluing, agglomerating, melding, associating, and bonding are synonyms that indicate the functionality and actions of a first onscreen object are joined to a second onscreen object, while the appearance of the joined objects is substantially the same as one of the two objects.

The method of the invention is not limited to dragging one object to overlap or intersect another object, or employing arrow logics to direct the combination of two object. Also, the system may provide a menu selection in which two selected objects are combined to include the traits of both objects, such as the appearance of one object and the functionality of the other object. Likewise, the combination may be elicited by use of an icon, a command statement, verbal command or commands, or any other computer input technique known in the art.

### BRIEF DESCRIPTION OF THE DRAWING

FIGS. 1A-1D are a sequence of screen displays depicting the steps of the method of the invention for combining two onscreen objects.

FIGS. 2A-2C are a sequence of screen displays depicting a further example of the steps of the method of the invention for combining two onscreen objects.

FIG. 3 is a depiction of an Info Canvas displayed in accordance with the method of the invention.

FIGS. 4A-4C are a sequence of screen displays depicting another example of the steps of the method of the invention for combining two onscreen objects.

FIG. 5 is a depiction of an Info Canvas displayed in accordance with the method of the invention.

FIGS. 6A-6D are a sequence of screen displays depicting a further example of the method of the invention for combining two onscreen objects.

### DETAILED DESCRIPTION OF THE INVENTION

The present invention generally comprises a method for user customization of a graphic user interface for an electronic device that includes a screen display. More specifically, the invention provides a system in which one onscreen object may be combined with a second onscreen object, and one of the onscreen objects may become invisible or touch transparent in the transaction. The user may interact with the visible onscreen object to access the invisible object.

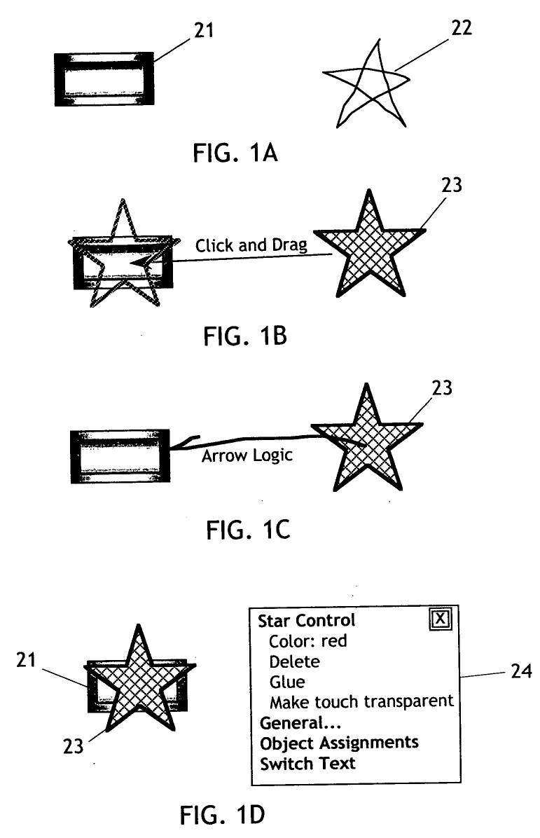

With regard to FIGS. 1A-1E, there is shown a sequence of views of onscreen objects on a computer display, and the user inputs required to carry out one embodiment of the method of the invention. In FIG. 1A, the display is exhibiting a switch 21, which is an onscreen object to which an assignment has been made, so that tapping or clicking or otherwise actuating the switch 21 causes a defined action to occur within the computer system. For example, the action may comprise calling forth a user-defined file such as a photo, audio, video, or text; establishing a network connection or email update; beginning playback of an audio or video file, or carrying out any user-defined or default transaction.

The user may wish to replace the appearance of the switch with a graphic that is more attractive, or which represents more explicitly the function of the switch 21. To create a star graphic element, the user draws a star 22, which is recognized by the software system and replaced by a star 23 as shown in FIG. 1B. The user may then cause the switch 21 and star 23 to overlap or intersect or otherwise be combined. As shown in FIG. 1B the user may click and drag on the star 23 to translate it to be superimposed on the switch 21, or may employ an appropriate arrow logic input, as shown in FIG. 1C to cause the same effect. In either case, the result shown in FIG. 1D is that the star 23 overlays the switch 21. The mere superposition of the two onscreen objects may be a sufficient action to cause the two objects to be glued together and combined as described below, based on the context of the action. As an alternative, however, a double tap/click or right click on the switch 21 elicits an Info Canvas 24 which displays significant data about the switch 21. Included in the Info Canvas is a user-selected item “Glue”, which indicates the user may select this item to cause the switch 21 to be glued or agglomerated with the red star 23. Likewise, the user may select “Make touch transparent” so that any click or tap imparted to the star 23 is passed through to the underlying switch 21. (Note that the Info Canvas for the red star 23 likewise could have been accessed and used to glue the two objects together.) Thus the agglomerated objects combine the function of the switch 21 with the appearance of the graphic object 23, thereby enabling customization of the screen display by the user.

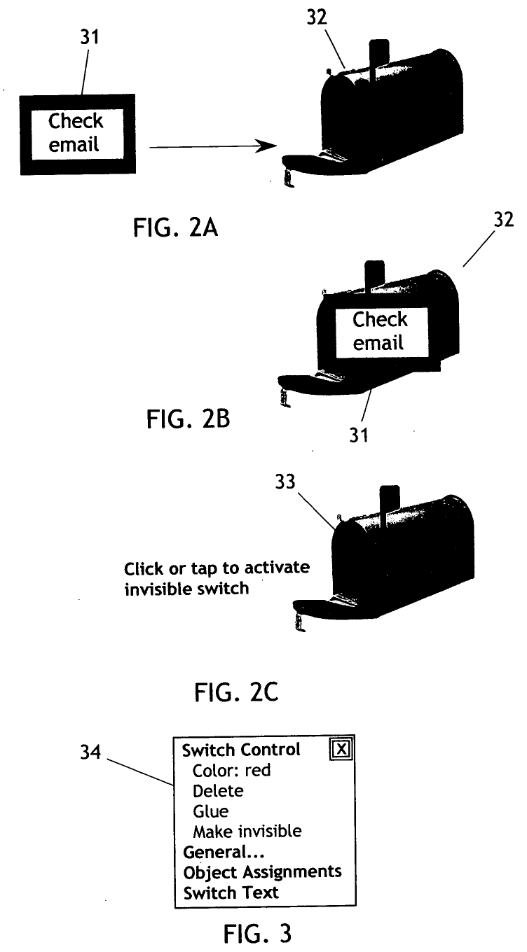

Another example of the method of the invention involves an onscreen object that accepts assignments, and an onscreen object that is a photo file. With regard to FIG. 2A, an onscreen object such as red switch 31 may be drawn or otherwise caused to be displayed. The red switch 31 may be assigned the action of checking email whenever the switch 31 is actuated by a click or tap or the like. The user may bring onto the display a photo 32 of an old mailbox, and bring the two objects 31 and 32 together to be superimposed or intersecting by dragging the switch 31 over the mailbox picture, as shown in FIG. 2B, or by the use of arrow logic transaction, or the equivalent. The context of this action may accomplish gluing the two objects together, as described previously, or the Info Canvas 34 (FIG. 3) of either object 31 or 32 may be accessed to carry out the gluing or agglomerating step, and the step of making the switch 31 invisible. Thereafter the switch 31 becomes invisible, and the agglomerated object 33 of FIG. 2C has the appearance of the photo 32 (a mailbox), while the functionality of the red switch 31 is maintained. Thus, the user may tap or click on the mailbox 33 to carry out the task of checking email.

Note that in general the manner in which an onscreen object (such as a switch) is made invisible (or touch transparent) may be carried out in any of several ways, such as a verbal command, a typed command, selecting an entry in a menu, drawing an arrow or other graphic object that initiates the action of making the object invisible or touch transparent, selecting both objects (as with a lasso) and gluing them together, and the like.

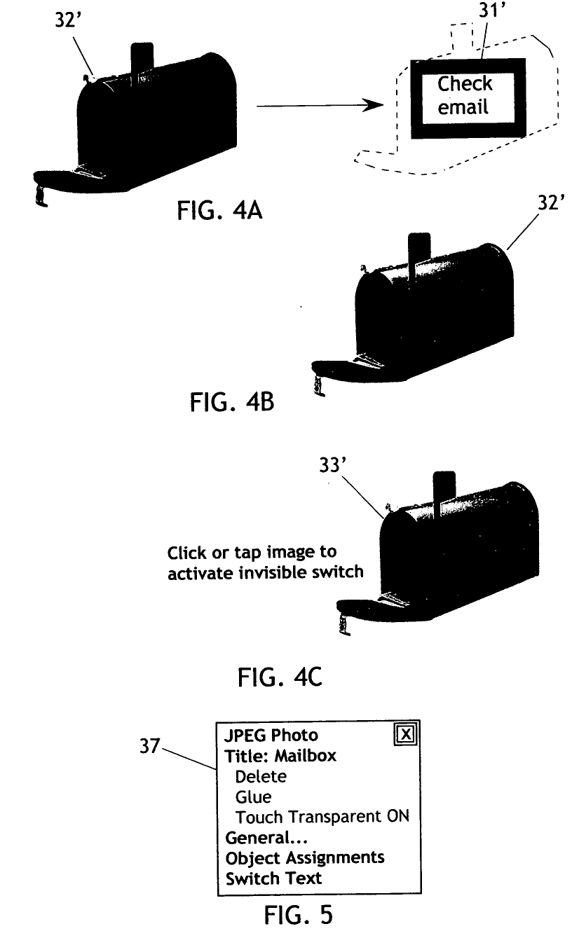

With regard to FIGS. 4A-4C, another example of a way to carry out the method of the invention involves bringing onscreen an image 32′ of a mailbox, and a switch 31′ labeled “Check email” (FIG. 4A). The user may drag or otherwise cause the image 32′ to be superposed over the switch 31′, as shown in FIG. 4B, whereby the switch 31′ is completely obscured. Generally speaking, in most operating systems an unseen onscreen object cannot be clicked, tapped, or activated unless it is made visible. However, as shown in FIG. 5, the user may call forth an Info Canvas for the image by double clicking/tapping or right clicking on the image 32′. The Info Canvas 37 provides a entry “Touch Transparent ON,” which, when selected, causes any touch or click applied thereafter to the image 33′ to be transferred to the underlying, unseen switch 31′. Thus once again two onscreen objects have been combined, and the combination provides the appearance of one object with the functionality of the other object.

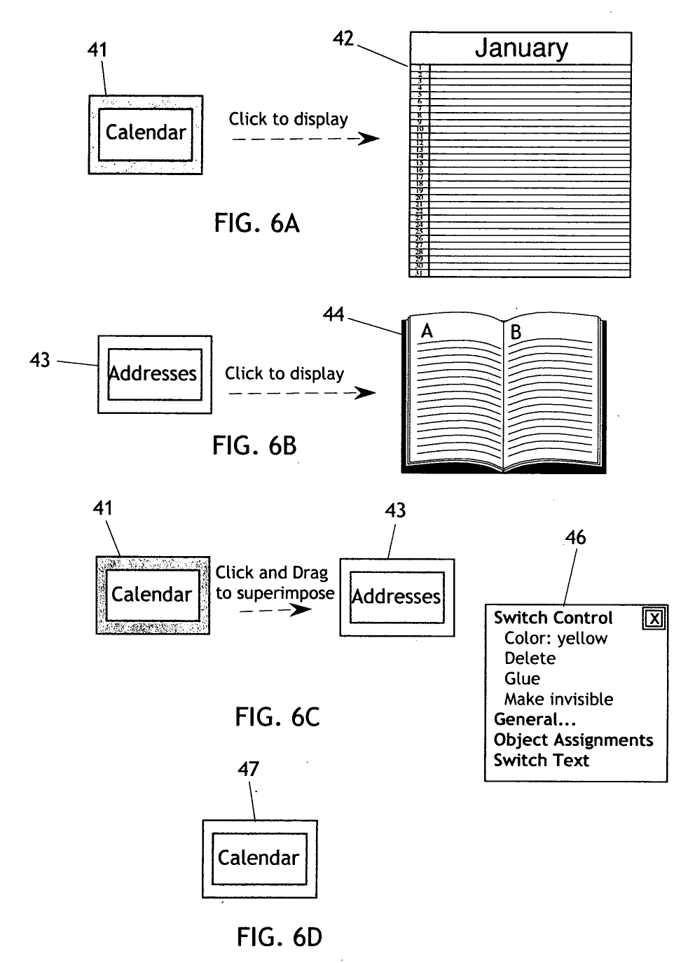

With reference to FIGS. 6A-6D, a further example of the method of the invention involves placing onscreen a first assigned-to object 41, such as switch 41. The assignment of the switch 41 is a calendar 42, which may contain personal date entries and the like. Clicking or tapping on switch 41 causes the calendar 42 to appear onscreen, and a subsequent click or tap causes the text to disappear. A second assigned-to object 43 may be placed onscreen (FIG. 6B), the object 43 being a switch that directs the display of an address book 44. With regard to FIG. 6C, the switch 41 may be agglomerated with the switch 43, by clicking and dragging, arrow logic command, menu selection, or the like. Thus two assigned-to objects are combined, a situation that is unlike any of the previous examples. The combination may be made explicitly by recourse to the Info Canvas 46 and selection of the “Glue” entry, or may be made implicitly by the context of the action (one assigned-to object being dragged over another assigned-to object).The combined switches form a toggle switch 47 (FIG. 6D). One click or tap on the toggle switch 47 calls forth onscreen the calendar 42, and the next click or tap on switch 47 causes the address book 44 to be displayed.

It may be appreciated that the software system may be encoded to recognize a range of hand drawn objects, such as rectangles, circles, stars, letters, triangles, and the like. These hand drawn objects may accept assignment of a wide variety of transactions, becoming powerful tools that can be redrawn onscreen at any time to be recalled for immediate use. The invention permits a second onscreen object that has no assignment, or is not capable of accepting assignment, to be agglomerated to an assigned-to object, so that the functionality of the assignment is coupled to the appearance of the second object. This capability greatly increases the variety and range of customizable onscreen objects, without substantially increasing the size of the code required for this customizable screen environment.

Note that any Info Canvas 24, 34, 37, or 46 that provides for an object to be glued to another will, when the glued state exists, provide a selection to “UnGlue” the two objects. Likewise, any Info Canvas that provides for an object to be made touch transparent or invisible will display the reverse entry, “Touch Transparent OFF” or “Make visible” to enable the user to cancel or reverse the action.

The examples described above indicate that the invention deals with two broad classes of onscreen objects: 1) those that have received an assignment, such as a function (i.e. switch, fader) or action (i.e., open a file, display a text portion), and, 2) those that have not received an assignment. The combination of an object that has an assignment either with an object that has no assignment, or another object that has an assignment, may be carried out through explicit user action, or may be accomplished merely by the context in which the two objects are combined. The following contexts are illustrative, but not limiting examples:

1. Dragging a first object over a second object having an assignment partially or completely obscures the second object, and automatically causes the first object to be touch transparent so that a click or tap applied to the first object is transmitted to the second, underlying object.

2. Simply gluing an assigned-to object to any graphic object, picture object, or video object results in the top object becoming touch transparent with respect to the bottom object.

3. Dragging an assigned-to object over a graphic object causes the assigned-to object to become invisible, but still functional, so that the graphic object is visualized and the functional object may be actuated by touch or click.

4. Dragging a graphic or photo object over a switch object, so that the perimeter of the switch remains visible, causes the overlying object to remain visible but become touch transparent. When the switch or overlying object is touched or clicked, the switch changes state and alters its color or brightness to indicate actuation.

5. Dragging one assigned-to object over another assigned-to object creates a combined onscreen toggle object, whereby clicking once on the combined object actuates the first object and clicking again actuates the second object.

This invention is adapted to be used with any electronic device that includes a screen display in which onscreen objects may be manipulated by a user to effect inputs into the electronic device.

The foregoing description of the preferred embodiment of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. In an electronic device having a screen display in which onscreen objects may be manipulated by a user to effect inputs into the electronic device, a method for combining onscreen objects including:
displaying first and second onscreen objects;
moving said first onscreen object to be at least partially superimposed on said second onscreen object;
rendering said first object invisible and maintaining said second object visible;
whereby the combination of the two objects has the appearance of said second object and a user may click/tap on said combination to actuate said first object.

2. The method of claim 1, wherein said first onscreen object is roved by clicking and dragging said first object to said second object.

3. The method of claim 1, wherein said first onscreen object is moved by arrow logic command entered by the user.

4. The method of claim 1, further including the step of gluing together said first and second object for conjoint movement on said display screen.

5. The method of claim 4, wherein said step of gluing includes accessing an Info Canvas and selecting an entry therein that glues together said first and second onscreen objects.

6. The method of claim 5, wherein said Info Canvas may be associated with either said first or second onscreen objects.

7. The method of claim 4, wherein said step of gluing is carried out automatically upon said first onscreen object being moved into at least partial superposition on said second onscreen object.

8. The method of claim 5, wherein said step of rendering said first object invisible is carried out by selecting an appropriate entry in said Info Canvas.

9. The method of claim 1, wherein said first onscreen object is a switch.

10. The method of claim 9, wherein said second onscreen object is a graphic object.

11. In an electronic device having a screen display in which onscreen objects may be manipulated by a user to effect inputs into the electronic device, a method for combining onscreen objects including:
displaying first and second onscreen objects;
moving said first onscreen object to be at least partially superimposed on said second onscreen object;
rendering said first object touch transparent;
whereby the combination of the two objects has the appearance of both objects and a user may click/tap on said first object to actuate said second object.

12. The method of claim 11, wherein said first onscreen object is moved by clicking and dragging said first object to said second object.

13. The method of claim 11, wherein said first onscreen object is moved by arrow logic command entered by the user.

14. The method of claim 11, further including the step of gluing together said first and second object for conjoint movement on said display screen.

15. The method of claim 14, wherein said step of gluing includes accessing an Info Canvas and selecting an entry therein that glues together said first and second onscreen objects.

16. The method of claim 15, wherein said Info Canvas may be associated with either said first or second onscreen objects.

17. The method of claim 14, wherein said step of gluing is carried out automatically upon said first onscreen object being moved into at least partial superposition on said second onscreen object.

18. The method of claim 15, wherein said step of rendering said first object touch transparent is carried out by selecting an appropriate entry in said Info Canvas.

19. The method of claim 11, wherein said first onscreen object is a graphic object.

20. The method of claim 19, wherein said second onscreen object is a switch.

21. In an electronic device having a screen display in which onscreen objects may be manipulated by a user to effect inputs into the electronic device, a method for combining onscreen objects including:
displaying first and second onscreen objects;
moving said first onscreen object to be superimposed on said second onscreen object and obscuring said second onscreen object;
rendering said first onscreen object touch transparent, whereby clicking on said first onscreen object causes said obscured, second onscreen object to receive and respond to the click.

22. The method of claim 21, wherein said first onscreen object is moved by clicking and dragging said first object to said second object.

23. The method of claim 21, wherein said first onscreen object is moved by arrow logic command entered by the user.

24. The method of claim 21, further including the step of gluing together said first and second object for conjoint movement on said display screen.

25. The method of claim 24, wherein said step of gluing includes accessing an Info Canvas and selecting an entry therein that glues together said first and second onscreen objects.

26. The method of claim 25, wherein said Info Canvas may be associated with either said first or second onscreen objects.

27. The method of claim 24, wherein said step of gluing is carried out automatically upon said first onscreen object being moved into superposition on said second onscreen object.

28. The method of claim 21, wherein said step of rendering said first object touch transparent is carried out by selecting an appropriate entry in said Info Canvas.

29. The method of claim 21, wherein said first onscreen object is a graphic object.

30. The method of claim 29, wherein said second onscreen object is a switch.

31. The method of claim 21, wherein the step of rendering said first onscreen object touch transparent is carried out automatically upon said first onscreen object being moved into superposition on said second onscreen object.

32. The method of claim 21, wherein the step of rendering said first onscreen object transparent includes accessing an Info Canvas and selecting an entry therein that makes said first onscreen object touch transparent.

33. The method of claim 32, wherein said Info Canvas may be associated with either said first or second onscreen objects.

34. In an electronic device having a screen display in which onscreen objects may be manipulated by a user to effect inputs into the electronic device, a method for combining onscreen objects including:
displaying first and second onscreen objects, each comprising a switch that is actuated by a click/tap;
moving said first onscreen object to be superimposed on said second onscreen object;
the combination of the two objects having the function of a toggle switch, whereby one click/tap on the combination causes the first object to be actuated and a second click/tap causes the second click/tap on the combination causes the second object to be actuated.
